(19) United States
(12) Patent Application Publication
(10) Pub. No.: US 2010/0005693 A1
(43) Pub. Date: Jan. 14, 2010

(54) Linen identification tags and system

(76) Inventors: Katrina Phelps Craycroft, Gig Harbor, WA (US); Andrew Boeh Craycroft, Gig Harbor, WA (US)

Correspondence Address: Oliver Law Firm, PS Inc., 1113 Hoyle Ln, Waxhaw, NC, 28173, US

(21) Appl. No.: 12/460,090

(22) Filed: Jul. 14, 2009

Related U.S. Application Data
(60) Provisional application No. 61/134,807, filed on Jul. 14, 2008.

(51) Int. Cl. G09F 3/16

(52) U.S. Cl. 40/360

(57) ABSTRACT

A Linen Identification Tag System for temporarily identifying linens can be used with sheets, towels, napkins, etc. Each linen identification tag comprises an attachment element and an identification element. The attachment element can be any appropriate type of mechanical or magnetic clip, and the identification element can be almost anything. It can hang from the clip or be adhered thereto. It can be soft as an embroidered applique or hard as a metal token. The system can be used by families or other groups traveling on vacation or can be used by clubs, companies, hotels, or others. The sets of Linen ID Tags can share a common theme. Using this identification system ensures that the same person uses the same linens over and over again so that germs are not shared between persons.

### RELATED APPLICATIONS

This application is related to and claims priority under 35 U.S.C. 119(e) to U.S. provisional application Ser. No. 61/134,807, entitled “Linen Identification Tags and System,” filed on Jul. 14, 2008, with inventors Katrina Craycroft and Andrew Craycroft, which is hereby incorporated by reference in its entirety.

### FIELD OF THE INVENTION

This invention pertains generally to identification methods for articles and more particularly to an apparatus and system for temporarily locating personal identification tags or other symbols on articles, esp. linens such as towels or napkins.

### BACKGROUND OF THE INVENTION

Towels, napkins, sheets, pillow cases, and other types of linens are frequently used more than once in a group setting. The group most often may be a family at home or at a hotel, but could be any other type of group, such as a club, a convention, a group home, or simply a group of friends traveling together. Regardless of the type of group, however, there exists the issue of identifying whose linen is whose. Especially in today's health-conscious society, people generally want to be sure that if one specific linen (towel, napkin, sheet, pillow case, etc.) is to be used a plurality of times between washings, it is used by the same person.

There are methods for permanently identifying linens for this purpose, such as marking, embroidering, and sewing in name tags. However, these methods are limited in scope and are often inefficient due to cost and lead time. Therefore, a method for quick, temporary identification is necessary that would address the issue. Such a temporary method could be used by families at home where linens are reused and then washed to be used by other family members, or could easily be portable to be used by the same family, e.g., in a hotel or motel where all the towels may look alike. It may also be important that the identification method not damage the underlying material—like stickers can. These tags and the methods for their use could also be used at clubs, hotels and other guesthouses, restaurants, public swimming pools, camps, or any other similar location.

For many years, single tags and stickers have been attached to luggage for identification, and some prior art patents have attempted to present enhanced systems for identifying luggage using stickers and additional tags. However, identifying linens presents a different set of problems than identifying luggage. For instance, linens are non-rigid and lightweight, and therefore can be damaged more easily. Linens do not need to be identified from a distance (as opposed to luggage on a baggage carousel). Linens are washed frequently (so stickers don't work because they can fall off or wash out completely or partially). Furthermore, linens are more personal than luggage and generally demand a more personal touch.

### SUMMARY OF THE INVENTION

The present invention solves the above-mentioned problems by providing a simple and effective way to identify linens (towels, cloth napkins, sheets, pillow cases, etc.) as temporarily belonging to one specific person—to perhaps be used a plurality of times before washing. The tags themselves, which may be soft labels such as cloth appliqués or name tags, or hard tokens, such as fashion jewelry or metal figures, are generally to be clipped onto the linens with a clip that will not damage the linen but will stay attached until positively removed by the user.

The apparatus of the invention may comprise an attachment element, such as a clip, with an identification element, such as a label, attached or linked thereto. The clip may be an alligator-style clip which will tightly grip the linen on a corner, edge, or fold, or may be a pinch-style clip which is generally easier to manipulate but might not have the same grip strength. The clip could also be any other type of appropriate clip. In alternate embodiments, the attachment elements may comprise magnetic clips instead of mechanical clips. In these embodiments, there will usually be two magnet portions that attract each other through the material of the linen with the identification element attached to at least one magnet portion. Obviously, this type of attachment may be easier to dislodge than a clip (lesser holding strength), but it may have the advantage of being easier to apply as well as being gentler on the material of the linen or other item. Pins may also be used instead of clips, but pins could be more damaging to the underlying material.

The identification element may be a soft element, such as a cloth appliqué, fabric label, PVC button, etc., or may be a hard element, such as a metal, plastic, or ceramic token or charm. It may be a relatively stiff button style element as opposed to a hanging or flexible element. The identification element also could be made removable, so that the user could attach a different identification element when desired—perhaps when a new member enters the family or club. If the Linen ID Tag System is to be sold in kits, e.g., for families going on vacation, there may be a similar, common theme shared by all of the tags—such as a beach or travel theme. Likewise, with clubs, the theme may be a company logo or proprietary design.

The system of the invention may comprise a plurality of these attachment elements and identification elements. The clips (attachment elements) are temporary and can be removed for washing the linens or for porting to a different location. The set of clips with identification elements being used is therefore flexible and versatile and can accommodate changing group members, changing tag preferences, and changing locations. For instance, each tag in a set could be assigned to a member of the family/group, to be associated with that member, and then that person's linen could be marked consistently with that particular tag or other identification element. The set could even be used as a “set of one” in certain situations. For instance, a conventioneer, forced by her employer to share a hotel room with a same-gender colleague might use a single tag to differentiate her towel from her roommate's which bears no tag whatsoever. Moreover, a kit may be provided for implementing the system. Such a kit may comprise a plurality of clips (or other attachment elements) of one or more types, a plurality of labels (or other identification elements) of one or more types, an instruction sheet or manual explaining how the system works, and may also include a travel organizer for porting the clips. Not only could the tags be used to identify each person's linens, but the tags could also be used to identify each person's belongings within a single linen, such as a travel organizer, beach bag, or other organizer with pockets or compartments for each person/member.

This method of using a set of embellishments to temporarily identify individual linens and to associate said linens with at least one specific user in a group can satisfy today's health-conscious society, in which people generally want to be sure that if one specific linen (towel, napkin, sheet, pillow case, etc.) is to be used a plurality of times between washings, it is used by the same person. The following disclosure will show how each of these embellishments may comprise an attachment element and an identification element linked thereto. Each identification element may be unique and distinct from the remaining identification elements (whether or not it is part of a common theme), and/or may be personal to its associated owner.

### BRIEF DESCRIPTION OF THE DRAWINGS

The objects, features, and advantages of the present invention will be apparent to one skilled in the art from reading the following description in which:

FIG. 1 is a perspective view of the preferred embodiment of the invention including a group of four alligator clips with soft appliqué labels;

FIG. 2A is a perspective view of a button-style identification element on an alligator clip;

FIG. 2B is a side view of a button-style identification element on a pinch clip;

FIG. 3 is a perspective view of an alternate embodiment of the invention including a group of eight pinch clips with hard tokens;

FIG. 4 is a perspective view of an alternate embodiment including a magnetic clip;

FIG. 5 is a perspective view of a travel organizer embodiment; and

FIG. 6 is a perspective view of the rolled and stowed travel organizer.

### DETAILED DESCRIPTION

The following specification describes an apparatus of a linen identification tag, a set of such tags, and system for using the identification tags. In the description, specific materials and configurations are set forth in order to provide a more complete understanding of the present invention. But it is understood by those skilled in the art that the present invention can be practiced without those specific details. In some instances, well-known elements are not described precisely so as not to obscure the invention.

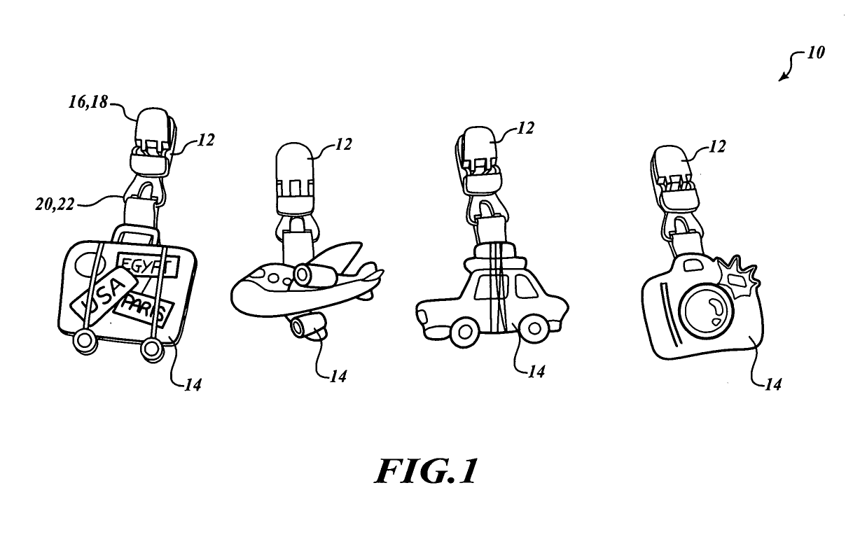

FIG. 1 shows that a set of identification tags 10 may comprise attachment elements 12 (alligator clips in this embodiment) and identification elements 14. Each attachment element will define a clip 16 at a first end 18 and an attachment point 20 at a second end 22. The attachment element typically will comprise a mechanical clip (alligator-style or pinch-style), but may alternatively be a magnetic clip typically having two magnet portions. The attachment element itself may be generally rectangular as in the illustration, but may also be round (esp. for magnetic clips), triangular, or of any other appropriate shape, regular or irregular. It may also be made of any appropriate material, e.g., plastic, wood, metal, and may even be covered with fabric or paper for further decoration. Furthermore, the attachment element could comprise a pin, snap, hook-and-loop fastener, or other mechanism instead of a clip, but clips (even magnetic ones) are preferred because they do not damage the material (linen).

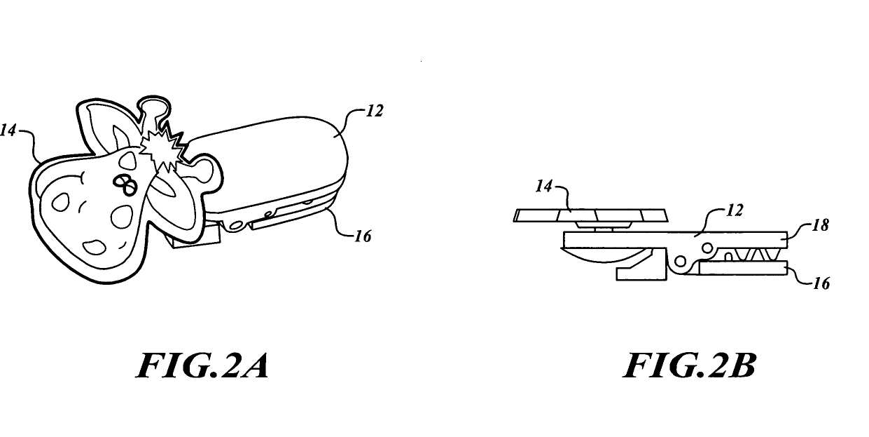

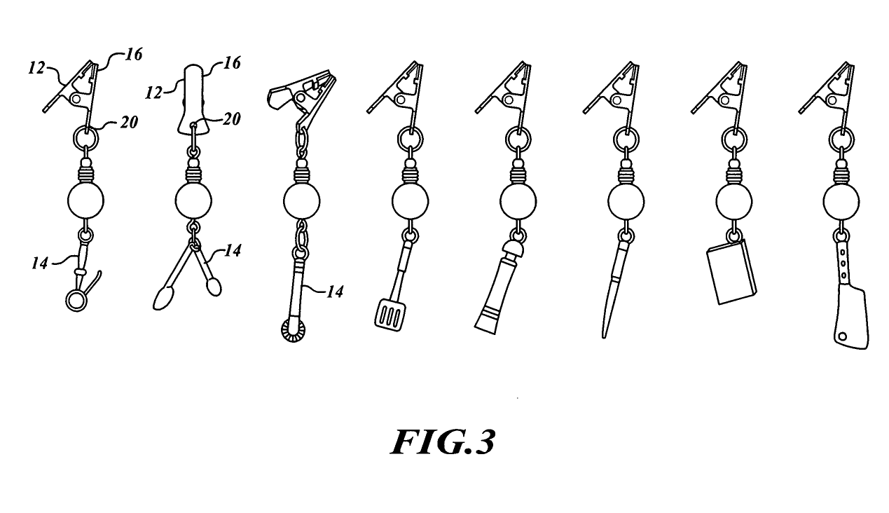

As the attachment elements are attached to the linens, likewise the identification elements 14 are attached to the attachment elements (either temporarily or permanently depending on the type) at the attachment points 20. In the illustration shown in FIG. 1, the identification elements 14 are soft fabric appliqués that loop around the attachment points and hang therefrom. In the illustration shown in FIG. 2A, the identification element 14 is a PVC button-style soft element, and fastens by extending a post through the loop of the attachment point 20 as seen in FIG. 2B. In alternate embodiments, the button-style soft element of the identification element 14 could be attached directly to a flat area of the attachment element (possibly using adhesive) toward either end of the clip. In even further alternate embodiments, the identification elements do not have to be directly attached at the attachment points, but could be linked thereto through a series of additional beads, loops, or other elements, such as in FIG. 3. Regardless of the attachment methods, one identification element attached to one corresponding attachment element creates one ID tag.

In the embodiment shown in FIG. 1, the identification elements chosen are soft appliqués, and each appliqué is different although they all belong to a similar, common theme. (Here the theme is travel. Other examples of themes may be beach, golf, food (such as the kitchen theme of FIG. 3), boating, or ancient Egypt, e.g.). Alternatively, the appliqué designs (many choices exist) or other type of fabric labels or soft or hard tokens or charms could be chosen to match each user's personality or some other characteristic, or could be simply assigned randomly to the individual users. If the tags are to be used for a club or company outing (such as a golf tournament), the identification elements could present the company's logo or some other proprietary design. The identification element could be soft or hard, plain or fancy, simple or complex. Color and texture may also be used to make the identification elements unique. As previously mentioned, the set could even be used as a “set of one” in certain situations. For instance, a single person, traveling as part of a touring group and sharing a hotel room with a same-gender group member might use a single tag to differentiate her towel from her roommate's which bears no tag whatsoever.

The identification elements 14 in this embodiment (FIG. 1) hang from the attachment points 20 which are rigid plastic loops, but obviously could be flexible (e.g., rubber) loops, smaller holes, metal stems, flat fabric tongues, or any other appropriate type of attachment point. Furthermore, the identification elements 14 could be attached in any other appropriate way (in addition to those illustrated in FIG. 1, 2A, 2B, or 3) such as with snaps, buttons, pins, adhesives, hook-and-loop fasteners, or even magnets. The identification elements may hang on cords, ribbons, rubber or metal rings or other linkages, or in any other applicable way.

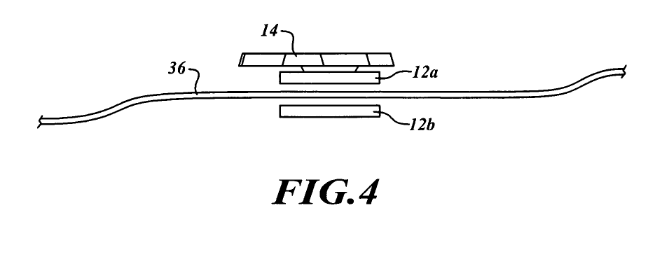

FIG. 4 shows one example of how a magnetic clip could work. The attachment element 12 may comprise two portions (being the polarized portions of the magnet), 12a and 12b, that will attract each other through the linen when positioned across from each other. The identification element 14 may be attached to one of the portions—here 12a—permanently, e.g., with glue, or temporarily, e.g., with Velcro™. Alternatively, the identification element 14 may be linked to the attachment element 12, e.g., through a series of rings and beads (as in FIG. 3).

Whether the system of ID tags is purchase “as is” or is built from a kit comprising attachment elements and identification elements, whether the tags share a common theme or not, and whether the tags are ported in a travel organizer or otherwise, the steps for using the system are the same. First, the attachment elements must be selected as appropriate for the linens and circumstances. For instance, more delicate linens, such as damask napkins in a fancy table setting, may require a more delicate touch—as with magnetic clips. Likewise, beach towels, sheets, or other linens that may be tossed and twisted, may require a stronger grip, such as from alligator clips. Next, each identification element must be associated with a particular user/temporary owner. As mentioned above, the association could be random, or different identification elements could be matched to their associated user's personality, for instance. Of course, the clips, magnetic, mechanical, or otherwise, but then be attached to the linens to make the necessary temporary identification. Depending on the type of clip and the demands of the situation, the clips may be washed with their respective linens or removed for washing or further porting to another location.

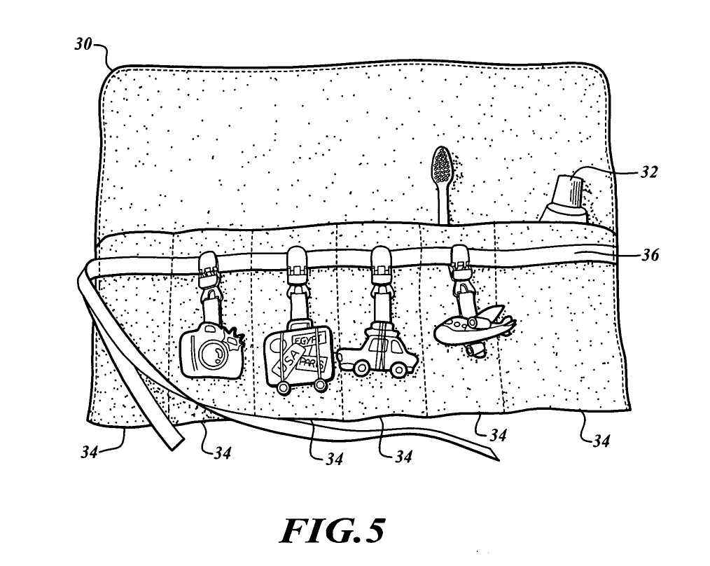

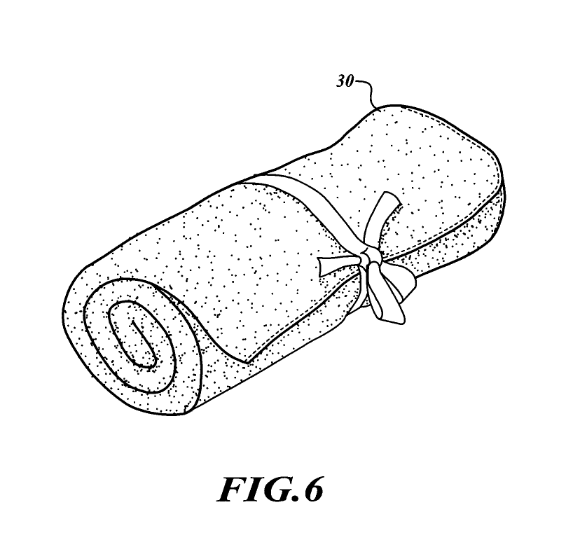

FIG. 5 shows how a travel organizer 30 can be used to transport and/or store one traveling group's toiletries or other items 32, such as toothbrushes and toothpaste, cosmetic brushes, lotions, medications, etc. In this case, the identification tags can be used to identify each person's pocket 34 and contents in the travel organizer 30. For instance, one person's toothbrush or other belongings can be packed into his/her assigned pocket and then that person's identification tag may be attached to a convenient, secure tag mounting point 36 (if provided) or alternately to the pocket front, towel edge, or any other convenient location. Obviously, with this type of travel organizer, the tags could be coordinated with bath towel charms, pillow case charms, etc, so that one person identifies with one particular charm/identification element. FIG. 6 shows how the travel organizer can be rolled and tied (or otherwise secured) for transportation and/or stowage so that the stowed items will not fall out.

Alternatively, the travel organizer 30 can be used to classify and transport the identification tags 10 themselves. If a group of persons is traveling together, each person may need a number of ID tags—such as for towel, pillow case, sheet, washcloth, etc.—to temporarily identify temporary ownership of these certain linens. In this case, a group of similar or identical ID tags is to be assigned to each person, and the travel organizer 30 offers a convenient way to transport the tags altogether to the travel destination instead of each person carrying his/her own tags. This travel tag organizer may comprise a plurality of pockets, and once they are separated into groups, the groups of ID tags can be packed into separate pockets of the travel tag organizer for transport. The travel tag organizer may then be secured as in FIG. 6 or otherwise so that the linen identification tags will not fall out during transport. The linen ID tags are then to be removed and associated with their respective owners at the travel destination. (If desired, one of the linen tags in the group can be mounted on the outside of the pocket for labeling and identification of that pocket.) The groups of linen tags can then be distributed to the respective owners for attachment to the certain linens or can be attached to the certain linens and then the linens distributed.

What is claimed is:

1. A set of linen identification tags comprising:
at least one attachment element defining a first end with a clip and a second end with an attachment point; and
at least one identification element, said at least one identification element corresponding to said at least one attachment element and being linked thereto at said attachment point.

2. The set of tags in claim 1 wherein said at least one clip is chosen from the group comprising alligator clips, pinch clips, and other mechanical clips.

3. The set of tags of claim 1 wherein said at least one clip comprises magnet portions.

4. The set of tags of claim 1 wherein said attachment point at said second end of said at least one attachment element comprises a loop, and said at least one identification element is linked therethrough.

5. The set of tags of claim 1 wherein there are at least two identification elements linked to at least two corresponding attachment elements and said at least two identification elements express a common theme.

6. A method of using a set of linen identification tags for temporarily identifying ownership of certain linens by associating said linens with their temporary owners and wherein said set of tags includes a plurality of attachment elements with clips and a plurality of corresponding identification elements linked thereto, said method comprising the steps of:
selecting said plurality of attachment elements that are appropriate for the linens and circumstances;
associating each of said identification elements with a temporary owner; and
temporarily attaching said clips of said attachment elements to the certain linens to be identified.

7. The method of claim 6 wherein at least one of said clips is magnetic, comprising two magnet portions, and attaching said clip comprises positioning said two magnet portions across the linen to attract each other.

8. The method of claim 6 wherein said clips are chosen from the group comprising alligator clips, pinch clips, and other mechanical clips.

9. The method of claim 6 further comprising the step of building said set of linen tags from a kit comprising attachment elements and identification elements.

10. The method of claim 6 wherein said set of linen tags expresses a common theme.

11. The method of claim 6 wherein at least one of said identification elements is chosen from the group comprising soft elements such as appliques, fabric labels, and PVC buttons.

12. The method of claim 6 wherein at least one of said identification elements is chosen from the group comprising hard elements such as metal tokens and ceramic charms.

13. The method of claim 6 further comprising the step of removing said temporary clips from said linens.

14. A method of using a set of embellishments to temporarily identify individual linens and to associate said linens with at least one specific user in a group, said embellishments each comprising an attachment element and an identification element linked thereto, each identification element being unique and distinct from the remaining identification elements in the set, said method comprising the steps of:
choosing a set of embellishments and associating each embellishment with at least one specific user;
choosing at least one linen to be temporarily owned by said specific user;
temporarily attaching said embellishment to said at least one linen in order to identify said linen with said specific user.

15. The method of claim 14 wherein said attachment elements comprise clips to temporarily attach to said linens.

16. The method of claim 15 wherein said plurality of identification elements share a common theme.

17. The method of claim 15 wherein each of said identification elements is personal to its associated user.

18. A method of using a travel tag organizer to classify and transport groups of linen identification tags to be used to temporarily identify temporary ownership of certain linens, said travel tag organizer comprising a plurality of pockets for said groups of linen identification tags, said method comprising the steps of:
separating a plurality of linen identification tags into groups;
packing each of said groups into one pocket of the travel tag organizer;
securing the travel tag organizer so that the linen identification tags will not fall out during transport;
transporting the travel tag organizer to the travel destination;
removing said groups of linen identification tags from the pockets of the travel tag organizer and associating them with their respective owners; and
attaching said linen identification tags to their certain linens in order to temporarily associate them with their respective owners.

19. The method of claim 18 further comprising the step of labeling the pockets of the travel tag organizer by mounting one of the linen identification tags of the group therein to the outside of said pocket.

20. The method of claim 18 wherein said linen identification tags comprise attachment elements and identification elements linked thereto, and said identification elements for the linen identification tags in each one of said groups are identical.
